(19) United States
(12) Patent Application Publication
(10) Pub. No.: US 2025/0357785 A1
(43) Pub. Date: Nov. 20, 2025

(54) METHOD FOR DISTRIBUTION OF PHASOR-AIDED STATE ESTIMATION TO MONITOR OPERATING STATE OF LARGE SCALE POWER SYSTEM AND METHOD FOR PROCESSING DEFECT DATA IN MIXED DISTRIBUTED STATE ESTIMATION BY USING SAME

(71) Applicant: POSTECH Research and Business Development Foundation, Pohang-si (KR)

(72) Inventors: Young Jin KIM, Pohang-si (KR); Jae Beom IM, Pohang-si (KR)

(73) Assignee: POSTECH Research and Business Development Foundation, Pohang-si (KR)

(21) Appl. No.: 18/250,181

(22) PCT Filed: Oct. 20, 2021
(86) PCT No.: PCT/KR2021/014721

§ 371 Date: Apr. 21, 2023

(30) Foreign Application Priority Data
Oct. 21, 2020 (KR) 10-2020-0136965
Oct. 20, 2021 (KR) 10-2021-0140064

(51) Int. Cl. H02J 13/00

(52) U.S. Cl. CPC H02J 13/00001; H02J 13/00002

(57) ABSTRACT

Disclosed are a method for distribution of PHASE to monitor the operating state of a power system by using heterogeneous data obtained from measurement of SCADA and a time synchronized PMU and a method for processing defect data in mixed DSE by using same. The method for distribution of PHASE to monitor the operating state of a large scale power system includes the steps of: defining an extended state variable and an extended state variable set for each region; performing a SCADA-based DSE by using a SCADA measurement value for each region and a covariance matrix thereof, and parallelly performing a PMU-based DSE by using a PMU measurement value for each region and a covariance matrix thereof; and mixing the estimation results of the SCADA-based and the PMU-based DSE algorithms so as to perform a phasor-aided normalized residual test and a general normalized residual test.

### CROSS-REFERENCE TO RELATED APPLICATIONS

This is a national stage application of PCT/KR2021/014721 filed on Oct. 20, 2021,which claims the benefit of and priority to Korean Patent Application No. 10-2020-0136965 filed on Oct. 21, 2020 and Korean Patent Application No. 10-2021-0140064 filed on Oct. 20, 2021, the entire contents of each of which are incorporated herein by reference for all purposes.

### BACKGROUND

### 1. Technical Field

The present invention relates to a decentralization strategy of phasor-aided state estimation (PHASE) for monitoring the operation of large-scale power systems, and more specifically, to a decentralized PHASE using heterogeneous hybrid data obtained from both supervisory control and data acquisition (SCADA) systems and phasor measurement units (PMUs), and a bad data processing (BDP) method in hybrid distributed state estimation (H-DSE) algorithm using the same.

### 2. Related Art

Conventional centralized state estimation (CSE) requires a one central coordinate system to manage, analyze, and process all big data measured from a large-scale power system. However, with the increase in the demand for electric power usage, power systems are expanding in size and complexity. Consequently, scalability issues arise, including rising data management and processing costs, and greater demands for high-performance communication infrastructure. Due to these issues, there has been a growing interest in decentralized state estimation (DSE) rather than CSE. The DSE algorithms have been proposed in many studies which can be categorized into two groups: hierarchical and fully distributed approaches. In hierarchical approaches, each local estimator acquires the state estimation (SE) result only in a sub-area. However, a single central estimator is still required to obtain global estimates by integrating with all the local SE results. In contrast, fully distributed approaches avoid the requirement for central coordination. Hence, fully distributed approaches have advantages in terms of high efficiency in data transmission and processing, reduced computation burden, data privacy and so on.

In recent research related to fully distributed approach, DSE algorithms such as the gossip-based, the Lagrangian relaxation, and the alternating direction method of multipliers (ADMM) have been employed.

The ADMM-based DSE operates under a global observability condition, rather than local observability. As a result, ADMM-based DSE requires fewer measurements for each sub-area compared to other DSE algorithms. In particular, the ADMM can effectively address local observability issues arising from the decentralization processes due to a reduction in measurements at boundary buses.

Meanwhile, PMUs can provide time-synchronized measurements based on the Global Positioning System (GPS) at short sampling intervals (60 Hz or 120 Hz in Korea) and thus allow for more accurate SE. However, SCADA measurements, which have been conventionally used for SE, are transmitted to an energy management system (EMS) once every 1-2 seconds and are not time-synchronized. Therefore, it is necessary to utilize precise PMU data to enhance the accuracy of SE. For this reason, extensive research has been conducted on hybrid SE in which two types of measurements with different characteristics are simultaneously used.

HSE can be classified into sequential and parallel approaches. The sequential approach performs SCADA-based SE initially and then refines the SE result by incorporating PMU measurements. On the other hand, the parallel approach performs SCADA-based SE and PMU-based SE simultaneously and integrate the two SE results. Compared to the sequential approach, which requires performing SE consecutively twice, the parallel approach offers a time-efficient alternative. However, to employ the parallel approach, it is imperative to ensure system observability globally solely using PMU data.

Meanwhile, regardless of the sequential or parallel approaches, conventional distributed HSE generally employs the largest normalized residual test (LNRT) method, which is a well-known BDP method. However, under conditions with multiple bad data (BD), the LNRT method has drawbacks of low accuracy in identifying BD, low computation efficiency, and an inability to determine the validity of critical measurements. In contrast, the phasor-aided state estimation (PHASE) method can identify and correct BDs by improving the aforementioned shortcomings through cross-validation between SCADA-based estimates and PMU-based estimates. However, the PHASE method has only been used in a centralized manner.

### SUMMARY

The present invention is directed to providing a decentralization strategy of HSE to monitor and analyze the system operations for distributed power systems based on SCADA measurements and time-synchronized PMU measurements.

The present invention is also directed to integrating a PHASE-based BDP method into a H-DSE algorithm based on SCADA and PMU measurements for effectively processing BD under multiple BD conditions.

The present invention is also directed to providing a decentralization strategy of the PHASE method to be integrated with H-DSE algorithm. This strategy addresses several challenges inconsistency between a state vector of SCADA-based DSE and one based on PMU measurements; the complexity of calculating a covariance matrix of estimated local state vectors; and the inconsistency between SCADA-based local gain matrices and PMU-based local gain matrices. Asa result, the PHASE method can be integrated into H-DSE algorithm.

To achieve the technical objectives, the present invention utilizes a local state vector extension and provides covariance matrices of expanded state vectors. These covariance matrices are employed to process BD in H-DSE algorithm using PHASE.

To monitor the operation of large-scale power systems, a decentralized PHASE (DPHASE) included the following stages: communicating information on location of metering devices and network topology; establishing the extended sets and the extended state vector for each sub-area on the basis of local measurements and communicated information; conducting SCADA-based DSE and PMU-based DSE in parallel using SCADA measurements and PMU measurements, respectively; integrating estimates from SCADA-based and PMU-based DSE algorithms; and performing both the phasor-aided normalized residual test and the general normalized residual test.

The parallel execution of the SCADA-based DSE and the PMU-based DSE involves estimating the local states of each sub-area using ADMM algorithm while interacting with adjacent local estimators.

After the performing of the phasor-aided normalized residual test and the general normalized residual test, the DPHASE method may determine whether there is BD in both the SCADA and PMU measurements for each sub-area.

If no BD is detected, the DPHASE method may further comprise fusing the results from the SCADA-based DSE and the PMU-based DSE algorithms.

Conversely, if BD is identified, the DPHASE method may further comprise removing the BD and recovering the data using a matrix completion method.

The DPHASE method may further comprise subsequently carrying out an additional DSE using the recovered SCADA and PMU measurements.

The additional DSE might generate new SCADA-based and PMU-based estimates by performing ADMM-based DSE in parallel.

After the performing of the additional DSE, the DPHASE method may further comprise fusing the results of the SCADA-based and the PMU-based DSE algorithms.

In accordance with another aspect of the present invention, a BDP method for monitoring the operating state of a large-scale power system within a H-DSE framework involves: mixing results from the SCADA-based and PMU-based DSE algorithms; performing both a phasor-aided normalized residual test and a general normalized residual test; determining the presence of BD in the SCADA and PMU measurements for each sub-area, which is distinguished or defined by a network topology related to the SCADA and the PMU measurements and position information of measurement equipment according to the network topology.

If no BD is detected, the BDP method may further comprise fusing the results from the SCADA-based DSE and the PMU-based DSE algorithms.

Conversely, if BD is identified, the BDP method may further comprise removing the BD and recovering data using a matrix completion method.

The BDP method may further comprise performing additional SE based on recovered SCADA and PMU measurements.

The performing of the additional DSE may comprise generating new SCADA-based and PMU-based estimates by performing ADMM-based DSE in parallel.

The BDP method may further comprise, after the performing of the additional DSE, fusing the estimation results of the SCADA-based DSE and the PMU-based DSE algorithms.

The BDP method may further comprise, before the performing of the phasor-aided normalized residual test and the general normalized residual test, establishing extended state vectors and an extended state vector set for each sub-area.

The BDP method may further comprise, after the establishing of the extended state vectors and the extended state vector set, performing the SCADA-based and the PMU-based DSE algorithms in parallel, wherein the performing of these algorithms may comprise generating SCADA-based and PMU-based estimated states of each sub-area while interacting with an adjacent estimator.

A device for performing a BDP method according to yet another aspect of the present invention for resolving the above-described technical objectives may comprise, as a device for performing a BDP method in H-DSE for monitoring an operating state of a large-scale power system, a memory that is configured to store at least one command; and a processor connected to the memory and configured to execute the at least one command, wherein, when the processor operates, the at least one command causes the processor to perform operations of: mixing estimation results of SCADA-based and PMU-based DSE algorithms and performing a phasor-aided normalized residual test and a general normalized residual test; and determining whether there is BD in SCADA and PMU measurements for each sub-area, wherein each sub-area is distinguished or defined by a network topology related to the SCADA and the PMU measurements and position information of measurement equipment according to the network topology.

After the determining of whether there is BD in the SCADA and the PMU measurements for each sub-area, the at least one command may cause the processor to further perform operations of: when there is BD, removing the BD and recovering data using a matrix completion method; performing additional DSE using SCADA and PMU data recovered in the recovering of the data wherein the performing of the additional DSE comprises performing ADMM-based DSE to generate additional SCADA and PMU measurements; and fusing the results of the SCADA-based and the PMU-based DSE algorithms.

After the determining of whether there is BD in the SCADA and the PMU measurements for each sub-area, the at least one command may cause the processor to further perform an operation of fusing the results of the SCADA-based and the PMU-based DSE algorithms when there is no BD.

Before mixing of the estimation results of the SCADA-based and the PMU-based DSE algorithms, and performing of the phasor-aided normalized residual test and the general normalized residual test, the at least one command may cause the processor to further perform the following step: receiving a network topology related to the SCADA and the PMU measurements, and position information of each piece of measurement equipment; establishing extended state vectors and an extended state vector set for each sub-area; performing the SCADA-based DSE algorithm using the SCADA measurement for each sub-area and a covariance matrix of integrated vectors of the SCADA and the PMU measurements; performing the PMU-based DSE algorithm using the PMU measurement for each sub-area and the covariance matrix of the integrated vectors of the SCADA and the PMU measurements in parallel with the SCADA-based DSE algorithm.

### BRIEF DESCRIPTION OF THE DRAWINGS

FIG. 1 is a conceptual diagram illustrating a DPHASE method which may be employed in a H-DSE algorithm according to an embodiment of the present invention.

FIG. 2 is an exemplary diagram of a power system which may be employed in the distribution method of FIG. 1 and includes two sub-areas.

FIG. 3 is a flowchart illustrating a main procedure of a H-DSE algorithm according to another embodiment of the present invention.

FIG. 4 is an exemplary diagram of a simulation power system illustrating SCADA and PMU measurement values in a 14-bus test network which may be employed in the H-DSE algorithm of FIG. 3.

FIGS. 5A and 5B are a set of graphs for comparing estimation errors of a voltage magnitude and a phase angle in the simulation power system of FIG. 4 when SCADA BD is included.

FIGS. 6A and 6B are a set of graphs for comparing estimation errors of a voltage magnitude and a phase angle in the simulation power system of FIG. 4 when PMU BD is included.

FIGS. 7A and 7B are a set of graphs for comparing estimation error AMAEs while increasing a BD error size and the number of pieces of BD in the simulation power system of FIG. 4 when SCADA BD is included.

FIGS. 8A and 8B are a set of graphs for comparing estimation error average maximum absolute errors (AMAEs) while increasing a BD error size and the number of pieces of BD in the simulation power system of FIG. 4 when PMU BD is included.

FIGS. 9A and 9B are a set of graphs for comparing computing times according to an increase or decrease in bad SCADA and PMU data ratios in the simulation power system of FIG. 4.

FIG. 10 is a block diagram illustrating a main device configuration that may be employed in a distribution method or a BDP method according to another embodiment of the present invention.

### DETAILED DESCRIPTION

Exemplary embodiments of the present disclosure are disclosed herein. However, specific structural and functional details disclosed herein are merely representative for purposes of describing exemplary embodiments of the present disclosure. Thus, exemplary embodiments of the present disclosure may be embodied in many alternate forms and should not be construed as limited to exemplary embodiments of the present disclosure set forth herein.

Accordingly, while the present disclosure is capable of various modifications and alternative forms, specific exemplary embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular exemplary embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present disclosure will be described in greater detail with reference to the accompanying drawings. In order to facilitate general understanding in describing the present disclosure, the same components in the drawings are denoted with the same reference signs, and repeated description thereof will be omitted.

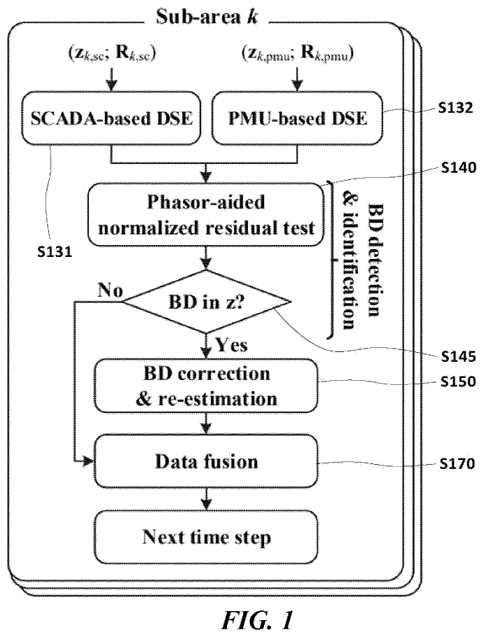

FIG. 1 is a conceptual diagram illustrating a DPHASE method which may be employed in a H-DSE algorithm according to an embodiment of the present invention.

Referring to FIG. 1, according to a H-DSE algorithm, SCADA measurement Z_{k,sc} for a specific sub-area k and a covariance matrix R_{k,sc} of the SCADA measurement are input so that SCADA-based DSE algorithm is performed (S131). In parallel with SCADA-based DSE, PMU measurement Z_{k,pmu} and a covariance matrix R_{k,pmu} of the PMU measurement are input so that PMU-based DSE algorithm is performed (S132).

SCADA measurement Z_{k,sc} and PMU measurement Z_{k,pmu} may be referred to as a SCADA measurement value and a PMU measurement value, respectively. DSE may be a simple expression of a distributed structure or distribution of SE.

Performing parallel SCADA-based DSE and PMU-based DSE involves a SCADA-based estimator and a PMU-based estimator obtaining SE results in parallel for each sub-area k using the SCADA measurement Z_{k,sc} and the PMU measurement Z_{k,pmu}, respectively. In addition, performing parallel SCADA-based and PMU-based DSE algorithms may involve an estimator of each sub-area interacting with an adjacent estimator and generating SCADA and PMU distribution states of each sub-area in parallel using ADMM-based DSE. Since the ADMM-based DSE does not employ a central estimator, parallel computing can be easily applied thereto. In other words, an estimator of each sub-area can share a SE value with an adjacent estimator in an overlapping sub-area between adjacent sub-areas and thus can have expandability.

Subsequently, cross-validation between the SCADA data and the PMU data is performed through a phasor-aided normalized residual test (S140).

In the cross-validation, normalized residuals are obtained by dividing conventional residuals by the square roots of diagonal elements in a covariance matrix of general residuals or the conventional residuals. Then, conventional residuals are redefined as differences between SCADA measurements and estimations of SCADA measurements employing PMU SE. Here, the SCADA measurements employing PMU SE are calculated using a SCADA-based measurement function and PMU-based estimation.

Also, SCADA estimation may correspond to estimation of SCADA measurement, SCADA-based estimation, or SCADA SE, and PMU estimation may correspond to estimation of PMU measurement, PMU-based estimation, or PMU SE. Here, only measurement functions corresponding to SCADA estimation and PMU estimation are applied. In other words, the measurement functions to be applied may include a first function representing that a value obtained by subtracting a SCADA-based measurement function for SCADA SE from a SCADA measurement is equal to a SCADA conventional residual, and a second function representing that a value obtained by subtracting a Jacobian matrix of a SCADA-based measurement function for PMU SE from a PMU measurement is equal to a PMU conventional residual. The Jacobian matrix of a SCADA-based measurement function is calculated on the assumption that a SCADA state vector is equal to a SCADA SE.

According to the cross-validation, a PHASE method may identify all measurements with a residual larger than a threshold value as BD.

Subsequently, it is determined whether there is BD in SCADA-based DSE and PMU-based DSE for the specific sub-area k (S145).

The cross-validation operation S140 and the BD determination operation S145 may correspond to a BD detection and identification process.

When it is determined in the BD determination operation S145 that there is BD (Yes in S145), BD correction and re-estimation are performed (S150). The BD correction and re-estimation may include an operation of removing BD and recovering data similar to an actual value using a matrix completion method and the like.

Subsequently, data fusion is performed by adding a product of a gain matrix of SCADA SE and a SCADA SE and a product of a gain matrix of PMU SE and a PMU SE (S170).

Meanwhile, when it is determined in the BD determination operation S145 that there is no BD (No in S145), a distribution device for implementing the distribution method of the present embodiment may fuse the SCADA data and the PMU data that has passed through the phasor-aided normalized residual test (S170).

According to the present embodiment, an ADMM-based H-DSE algorithm is integrated with a PHASE method to improve BDP performance. In other words, according to the PHASE method, all measurements having a residual larger than a threshold value are identified as BD and can be removed at once rather than being removed one by one, which is more efficient in terms of calculation. Accordingly, due to the phasor-aided normalized residual test, BD corresponding to multiple interactions can be effectively identified and thus effectively removed. Also, compared to a conventional BDP method, for example, a LNRT, the phasor-aided normalized residual test can significantly improve the accuracy of BDP.

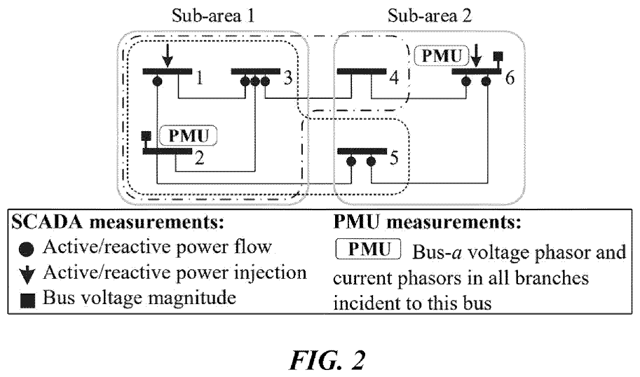

FIG. 2 is an exemplary diagram of a power system which may be employed in the distribution method of FIG. 1 and includes two sub-areas.

Referring to FIG. 2, in a power system installed in two sub-areas (sub-area 1 and sub-area 2), measurement devices or measurement equipment for SCADA measurement and PMU measurement is installed at specific positions of the power system having six buses 1, 2, 3, 4, 5, and 6, and a bus that is observable by each piece of measurement equipment is indicated by a solid line.

As SCADA measurement values, active/reactive power flows, active/reactive power injections, and bus voltage magnitudes are represented in the shapes of circles, arrows, and rectangles, respectively.

PMUs measure a voltage magnitude and a voltage phasor of a specific installed bus and also measure current magnitudes and current phasors of all branches connected to the specific bus. To ensure global system observability, two PMUs are separately installed in the bus 2 and the bus 6 in the form of a quadrangular box with rounded corners in which “PMU” is shown.

A state vector of a power system is represented with a voltage magnitude and a phase. When the voltage magnitude and phase of a specific bus can be calculated from given measurement data, the bus is referred to as being observable.

In sub-area 1 of FIG. 2, buses observable from SCADA measurement values are the buses 1 to 4, and buses observable from PMU measurement values are the buses 1, 2, 3, and 5. Accordingly, in sub-area 1, the buses observable from SCADA measurement values differ from the buses observable from PMU measurement values.

In general, measurement equipment related to SCADA measurement has a different position and different type of measurement data from measurement equipment related to PMU measurement, and thus state vectors which are observable on the basis of SCADA measurement values do not correspond to state vectors which are observable on the basis of PMU measurement values. In addition, a local gain matrix based on SCADA measurement values and a PMU-based local gain matrix required for fusing estimation values do not correspond to each other.

Accordingly, in the present embodiment, the above problems caused by differences in position and the type of measurement data between measurement equipment related to SCADA measurement and measurement equipment related to PMU equipment are solved through DPHASE as described above with reference to FIG. 1. Such DPHASE, that is, DSE to which PHASE is applied (also referred to simply as “H-DSE”) will be described in further detail below.

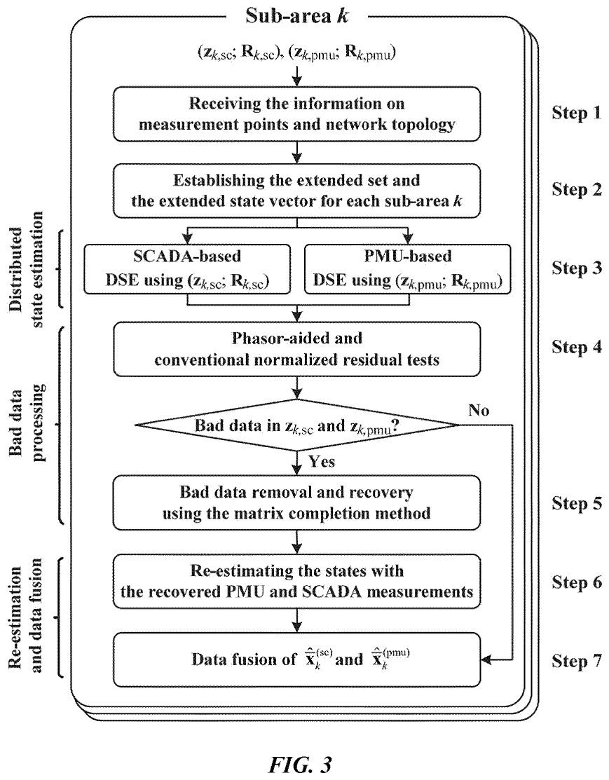

FIG. 3 is a flowchart illustrating a main procedure of a H-DSE algorithm according to another embodiment of the present invention.

Referring to FIG. 3, the H-DSE algorithm includes four major elements in a process of applying a PHASE method.

The four elements include extension of local state vectors, DSE, BDP, and re-estimation and data fusion parts.

The local state vector extension part selectively includes an operation (step 1) of receiving a network topology and measurement equipment positions or information on measurement points and thus may include only an operation (step 2) of establishing extended state vectors and an extended state vector set for each sub-area.

The DSE part may be referred to as ADMM-based DSE including a SCADA-based DSE operation employing SCADA measurement values and covariance matrices thereof and a PMU-based DSE operation employing PMU measurement values and covariance matrices thereof. In this case, ADMM-based DSE may include not only a parallel estimation operation (step 3) of a SCADA-based DSE operation and a PMU-based DSE operation but also an operation (step 6) of re-estimating the previously estimated states using recovered PMU and SCADA measurements.

The BDP part may include an operation (step 4) of performing a phaser-aided normalized residual test and a conventional normalized residual test, an operation of determining whether there is BD in SCADA measurement values and PMU measurement values for each sub-area k, and an operation (step 5) of performing BD removal and data recovery using a matrix completion method and the like when there is BD.

The above-described H-DSE algorithm will be described in further detail below.

First, in the local state vector extension operation, extended state vectors and an extended state vector set for each sub-area are established through power system network topology information and position information of each piece of measurement equipment (step 2). The extended state vector set may include extended state vectors. Here, a network topology and measurement equipment positions or information on measurement points may be stored in advance in a memory or storage device.

Subsequently, DSE based on SCADA data and DSE based on PMU data are performed in parallel (step 3). Here, the DSE may employ the foregoing ADMM.

Subsequently, in the BDP operation employing the PHASE method, a phasor-aided normalized residual test and a normalized residual test are performed (step 4), and it is determined whether there is BD through cross-validation between test results.

Measurement data determined to be BD may be removed, and data similar to an actual value may be recovered using the matrix completion method (step 6).

Subsequently, DSE of the third operation (step 3) is performed again using the recovered SCADA and PMU data, and a state is finally estimated by fusing estimation results (step 7).

In addition to the above description, state vector extension in the local state vector extension operation (step 2) may cause the problem of observability of a local state estimator at the boundary between sub-areas. In the present embodiment, this problem is solved through the ADMM.

To solve a distribution optimization problem, in the ADMM, information of adjacent sub-areas is repeatedly exchanged, and a global optimal solution is calculated. Here, a local power system can be observed using information exchanged with information of an adjacent sub-area as a pseudo-measurement value.

When a set of buses which can be estimated from SCADA data for an arbitrary sub-area k is Ω_{k,sc} and a set of buses which can be estimated from PMU data is Ω_{k,pmu}, a set Ω̅ₖ of buses which can be estimated and are defined through state vector extension is given below.

$${\overline{Ω}}_{k} := {Ω}_{k , sc} ⋃ {Ω}_{k , pmu} , ∀ k \qquad [ Equation 1 ]$$

As examples of sets of extended buses which can be estimated including sets of buses which can be estimated from data with reference to FIG. 2, a set Ω̅₁ of buses which can be estimated in sub-area 1 and a set Ω̅₂ of buses which can be estimated in sub-area 2 are defined as {B1, B2, B3, B4, B5} and {B2, B4, B5, B6}, respectively. Here, a set of buses which can be estimated from SCADA data for £1 is defined as {B1, B2, B3, B4}, and a set of buses which can be estimated from PMU data for Ω̅₁ is defined as {B1, B2, B3, B5}. Bk is a k-th bus (bus k).

Also, an extended state vector may be defined by the following relational expression using a state vector X_{k.sc} which can be estimated by a SCADA-based local estimator of the sub-area k, an extended state vector X̅ₖ, and a shared state vector \tilde{X}_{k,sc}.

$${\overline{Π}}_{k , sc} {\overline{x}}_{k} = {[ {x}_{k , sc}^{T} {\tilde{x}}_{k , sc}^{T} ]}^{T} \qquad [ Equation 2 ]$$

$$where {\overline{Π}}_{k , sc} := {[ {Π}_{k , sc}^{T} {\tilde{Π}}_{k , sc}^{T} ]}^{T}$$

Here, Π is a permutation matrix. An extended state vector represents the same state regardless of SCADA or a PMU and thus is not distinguished by a subscript. Other state vectors for a PMU may be expressed similar to Equation 2.

In Equation 2, the permutation of SCADA-based extended state vectors of the sub-area k is equal to a transpose matrix of a product of a transpose matrix of state vectors which can be estimated on the basis of SCADA and a transpose matrix of shared state vectors.

Secondarily, for DSE of a power system divided into a plurality of (e.g., K) sub-areas, the optimization problem may be formalized through a weighted-least squares (WLS) method as follows.

$${min}_{\{ {\overline{x}}_{k} ∈ {\overline{𝒳}}_{k} \}} {\sum }_{k = 1}^{K} {\overline{f}}_{k , pmu} ( {\overline{x}}_{k} ) \qquad [ Equation 3 ]$$

$$subject to {z}_{k , pmu} = {H}_{k , pmu} {Π}_{k , pmu} {\overline{x}}_{k} + {e}_{k , pmu} , ∀ k ,$$

$${\overline{x}}_{k} [ l ] = {\overline{x}}_{l} [ k ] , \qquad ∀ l ∈ {\overline{𝒩}}_{k} , \qquad ∀ k ,$$

$$where {\overline{f}}_{k , pmu} ( {\overline{x}}_{k} ) = ( \frac{1}{2} ) {( {z}_{k , pmu} - {H}_{k , pmu} ( {Π}_{k , pmu} {\overline{x}}_{k} ) )}^{T} \cdot {R}_{k , pmu}^{- 1} \cdot ( {z}_{k , pmu} - {H}_{k , pmu} ( {Π}_{k , pmu} {\overline{x}}_{k} ) )$$

An objective function of Equation 3 is the sum of SE objective functions of the K sub-areas, and the constraints are sequentially a measurement value function, a consensus constraint, and an area-specific WLS objective function. In Equation 3,

$${R}_{k , sc}^{- 1}$$

is an inverse matrix of a covariance matrix of SCADA data in the sub-area k. A solution to the distribution optimization problem is a global SE value.

When the ADMM is applied to solve the distribution optimization problem, an optimal solution may be obtained by repeatedly calculating the following equations.

$${\overline{x}}_{k}^{t + 1} = arg {min}_{{\overline{x}}_{k} ∈ {\overline{𝒳}}_{k}} {L}_{k , sc} ( {\overline{x}}_{k} ) , ∀ k , = arg {min}_{{\overline{x}}_{k} ∈ {\overline{𝒳}}_{k}} {\overline{f}}_{k , sc} ( {\overline{x}}_{k} ) + \frac{{c}_{sc}}{2} {\sum }_{i = 1}^{{\overline{N}}_{k}} \vert {\overline{𝒩}}_{k}^{i} \vert {( {\overline{x}}_{k} ( i ) - {\overline{p}}_{k}^{t} ( i ) )}^{2} , ∀ k , \qquad [ Equation 4 ]$$

$${\overline{s}}_{k}^{t + 1} ( i ) = \frac{1}{\vert {\overline{𝒩}}_{k}^{i} \vert} {\sum }_{l ∈ {\overline{𝒩}}_{k}^{i}} {\overline{x}}_{l}^{t + 1} [ i ] , ∀ i , ∀ k , {\overline{𝒩}}_{k}^{i} \neq ∅ \qquad [ Equation 5 ]$$

$${\overline{p}}_{k}^{t + 1} ( i ) = {\overline{p}}_{k}^{t} ( i ) + {\overline{s}}_{k}^{t + 1} ( i ) - \frac{{\overline{x}}_{k}^{t} ( i ) + {\overline{s}}_{k}^{t} ( i )}{2} , ∀ i , ∀ k , {\overline{𝒩}}_{k}^{i} \neq ∅ \qquad [ Equation 6 ]$$

In Equation 4 to Equation 6, the subscript of k denotes a sub-area, i denotes an element of a matrix or vector, l denotes a sub-area l adjacent to the sub-area k, [symbol] denotes a set of sub-areas adjacent to the sub-area k, and t denotes the number of times that the ADMM is repeated.

Equation 4 above is a process of estimating an area-specific state vector and may be calculated through the Lagrangian equation of Equation 3. Here, C_{sc} is a penalty parameter that is an element for determining a weight of the consensus constraint.

In Equation 5 and Equation 6, vectors s and p are vectors induced by a Lagrangian multiplier and the consensus constraint.

Equation 4 may be calculated as shown in Equation 7 below.

$${\overline{G}}_{k}^{( sc )} ( {\overline{x}}_{k}^{\{ n \}} ) Δ {\overline{x}}_{k} = \{ ( {( {H}_{k , sc}^{( sc )} {Π}_{k , sc} )}^{T} {R}_{k , sc}^{- 1} ( {z}_{k} - {h}_{k , sc} ( {Π}_{k , sc} {\overline{x}}_{k}^{\{ n \}} ) ) + {c}_{sc} {\overline{D}}_{k} ( {\overline{p}}_{k}^{t} - {\overline{x}}_{k}^{\{ n \}} ) \} = - {g}_{k , sc} ( {\overline{x}}_{k}^{\{ n \}} ) , {\overline{x}}_{k}^{\{ n + 1 \}} = {\overline{x}}_{k}^{\{ n \}} + Δ {\overline{x}}_{k} , \qquad [ Equation 7 ]$$

$$where {\overline{G}}_{k}^{( s c )} ( {\overline{x}}_{k} ) = {( {H}_{k , sc}^{( s c )} {Π}_{k , s c} )}^{T} {R}_{k , sc}^{- 1} {H}_{k , sc}^{( s c )} {Π}_{k , sc} + {c}_{sc} {\overline{D}}_{k}$$

$$In Equation 7 , {\overline{G}}_{k}^{( sc )} ( {\overline{x}}_{k}^{\{ n \}} ) is a gain matrix for SCADA data for {\overline{x}}_{k}^{\{ n \}} . {H}_{k , sc}^{( sc )}$$

is a Jacobian matrix of h_{k,sc}(X) for x=Π_{k,sc}X̅ₖ, and D̅ₖ is an N̅ₖ×Nₖ diagonal matrix representing an (i, i) element as an absolute value | [symbol] | of a set of sub-areas adjacent to the sub-area k.

A SCADA-based final estimation value

$${\hat{x}}_{k , sc}^{( sc )}$$

may be obtained by repeatedly calculating Equation 7. Similarly, a PMU-based final estimation value

$${\hat{x}}_{k , pmu}^{( pmu )}$$

may be calculated for a PMU.

After the ADMM-based DSE, a BDP operation employing PHASE is performed. PHASE is a method of determining BD through cross-validation between results of two normalized residual tests and is useful when there are two or more independent measurement data sets.

The following is a description of a case in which BD is included in SCADA data, and it may also be determined whether BD is included in PMU data similarly. Equation 8 and Equation 9 below may be calculated using extended state vectors.

$${r}_{k , pmu}^{( sc )} := {z}_{k , pmu} - {\hat{z}}_{k , pmu}^{( sc )} = {z}_{k , pmu} - {H}_{k , pmu} {Π}_{k , pmu} {\hat{\overline{x}}}_{k}^{( sc )} , ∀ k . \qquad [ Equation 8 ]$$

$${r}_{k , sc}^{( pmu )} := {z}_{k , sc} - {\hat{z}}_{k , sc}^{( pmu )} = {z}_{k , sc} - {H}_{k , sc} {Π}_{k , sc} {\hat{\overline{x}}}_{k}^{( pmu )} , ∀ k . \qquad [ Equation 9 ]$$

Equation 8 is a definition of a general residual, and Equation 9 is a definition of a phasor-aided residual.

A phasor-aided residual is a value calculated using SCADA data and independent PMU data. When BD is included in the SCADA data, the phasor-aided residual has a relatively large value. A covariance matrix

$${\overline{V}}_{k , sc}^{( pmu )}$$

for normalizing a phasor-aided residual is calculated according to Equation 10 below.

$${\overline{V}}_{k , sc}^{( pmu )} = {R}_{k , sc} + {\overline{M}}_{k , sc}^{( pmu )} , ∀ k , \qquad [ Equation 10 ]$$

$$where {\overline{M}}_{k , sc}^{( pmu )} = {H}_{k , sc}^{( pmu )} {Π}_{k , sc} {\overline{S}}_{k , pmu} {{Π}_{k , sc}^{T} ( {H}_{k , sc}^{( pmu )} )}^{T} ,$$

$${\overline{S}}_{k , pmu} = {( {\overline{H}}_{k , pmu}^{T )} {\overline{R}}_{k , pmu}^{- 1} {\overline{H}}_{k , pmu} )}^{- 1} ,$$

$${\overline{H}}_{k , pmu} = {[ {( {H}_{k , pmu} {Π}_{k , pmu} )}^{T} {\overline{D}}_{k}^{1 / 2} ]}^{T} ,$$

$${\overline{R}}_{k , pmu} = diag ( {R}_{k , pmu} , {P}_{k , pmu} ) .$$

Here,

$${H}_{k , sc}^{( pmu )}$$

is a Jacobian matrix of a SCADA measurement value function h_{k,sc} (·)for

$${x}_{k , s c} = {\prod }_{k , sc} {\hat{\overline{x}}}_{k}^{( pmu )}$$

and is calculated as follows.

As shown in Equation 10, a covariance matrix of a phasor-aided residual

$${r}_{k , sc}^{( p m u )}$$

is calculated as the sum of a matrix R_{k,sc} in which diagonal elements are variances of SCADA measurement values and a covariance matrix of

$${\hat{z}}_{k , s c}^{( p m u )}$$

because SCADA measurement values and PMU measurement values are independent.

Then, the phasor-aided residual

$${r}_{k , sc}^{( p m u )}$$

is normalized using

$${\overline{v}}_{k , sc}^{( p m u )} .$$

The normalized residual is compared with a threshold value which is a statistical value to determine whether the residual corresponds to bad data. A threshold value satisfying a confidence level of 99.7% may be calculated to be 3, and a threshold value satisfying a confidence level of 95.4% may be calculated to be 2.

Equation 11 below represents a phasor-aided normalized residual test.

$${r}_{{N}_{k , sc}}^{( p m u )} ( i ) : = \frac{{r}_{k , sc}^{( p m u )} ( i )}{\sqrt{{\overline{V}}_{k , sc}^{( p m u )} ( i , i )}} \leq μ , ∀ k . \qquad [ Equation 11 ]$$

In Equation 11, μ is a threshold value. When data has a normalized residual smaller than the threshold value, the data is normal data. When data has a normalized value larger than the threshold value, the data belongs to a BD candidate group.

A general normalized residual test is also performed in a similar way to the phasor-aided residual test. In the general normalized residual test, a state value estimated from SCADA to determine whether a SCADA measurement value is bad is used as a residual. The following is a general normalized residual test.

$${y}_{{N}_{k , sc}}^{( s c )} ( i ) ≡ \frac{{y}_{i , sc}^{( s c )} ( i )}{\sqrt{{\overline{U}}_{k , sc}^{( s c )} ( i , i )}} \leq μ , ∀ k . where , \qquad [ Equation 12 ]$$

$${\overline{U}}_{k , sc}^{( s c )} = {R}_{k , s c} - {\overline{T}}_{k , sc}^{( s c )} , ∀ k ,$$

$${\overline{T}}_{k , sc}^{( s c )} = {{H}_{k , s c} ( {H}_{k , s c}^{T} {R}_{k , sc}^{- 1} {H}_{k , sc} )}^{- 1} {H}_{k , s c}^{T} , ∀ k$$

Unlike a covariance matrix of phasor-aided normalized residuals, a covariance matrix of general normalized residuals appears as a difference between a covariance matrix R_{k,sc} of measurement values and a covariance matrix of

$${\hat{z}}_{k , sc}^{( s c )} .$$

The corresponding result occurs because SCADA-based estimation values are in a dependent relationship with SCADA measurement values. A measurement value of which residuals exceed threshold values in both residual tests is determined as final BD.

Here, an equation for determining whether a PMU measurement value is bad will be omitted. However, it is to be noted that a PMU BD determination process is similar to the SCADA BD determination process.

Measurement values determined to be bad may be removed, and approximate measurement values may be recovered using the matrix completion method.

In the final operation, a SCADA-based estimation result and a PMU-based estimation result are fused together. A SE result for the bus set of the expanded sub-area k may be calculated according to Equation 13 below.

$${\overline{G}}_{k}^{( sc )} + {\overline{G}}_{k}^{( pmu )} {\hat{\overline{X}}}_{k} = {\overline{G}}_{k}^{( sc )} {\hat{\overline{X}}}_{k} + {\overline{G}}_{k}^{( pmu )} {\hat{\overline{X}}}_{k}^{( pmu )} , ∀ k . where , \qquad [ Equation 13 ]$$

$${\overline{G}}_{k}^{( s c )} = {( {H}_{k , sc}^{( s c )} {\prod }_{k , s c} )}^{T} {R}_{k , sc}^{- 1} {H}_{k , sc}^{( sc )} {\prod }_{k , s c} + {c}_{s c} {\overline{D}}_{k} , and ,$$

$${\overline{G}}_{k}^{( p m u )} = {( {H}_{k , p m u} {\prod }_{k , p m u} )}^{T} {R}_{k , pmu}^{- 1} {H}_{k , pmu} {\prod }_{k , pmu} + {c}_{s c} {\overline{D}}_{k} .$$

In Equation 13,

$${\overline{G}}_{k}^{( s c )} and {\overline{G}}_{k}^{( p m u )}$$

are a gain matrix of SCADA-based estimation values

$${\hat{\overline{x}}}_{k}^{( s c )}$$

and a gain matrix of PMU-based estimation values

$${\hat{\overline{x}}}_{k}^{( p m u )} ,$$

respectively. An extended state vector set makes the row size and column size and the row indices and column indices of

$${\overline{G}}_{k}^{( s c )}$$

the same as those of

$${\overline{G}}_{k}^{( pmu )}$$

Accordingly, a SCADA-based estimation value and a PMU-based estimation value can be fused together.

An embodiment of the present invention has been compared with the three conventional methods, and performance thereof has been evaluated. The present invention is DPHASE employing PHASE. Comparative example 1 of the compared methods is DSE not employing BDP (DSE w/o BDP), comparative example 2 is DSE to which an LNRT BDP method is applied (DSE-LNRT), and comparative example 3 is robust DSE (RDSE). RDSE is a BDP method employing L1-relaxation.

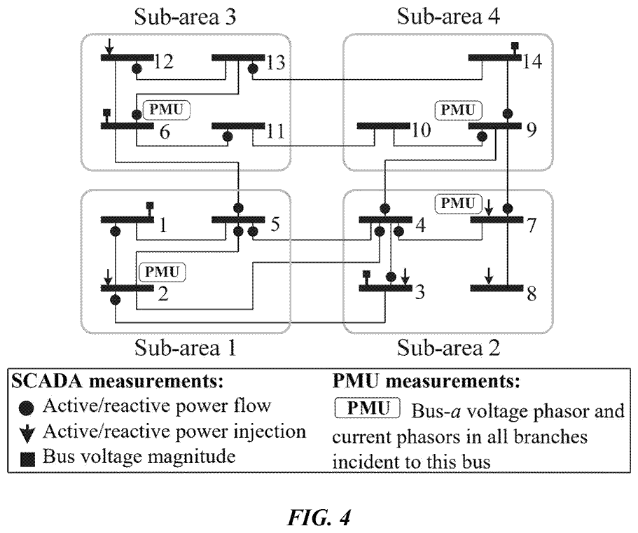

FIG. 4 is an exemplary diagram of a simulation power system illustrating SCADA and PMU measurement values in a 14-bus test system which may be employed in the H-DSE algorithm of FIG. 3.

The simulation power system of FIG. 4 corresponds to the IEEE 14-bus system for which SE of the present embodiment and the comparative examples are performed.

Referring to FIG. 4, the simulation power system is divided into four sub-areas: sub-area 1, sub-area 2, sub-area 3, and sub-area 4. In the simulation power system, four PMUs are installed, and SCADA measurement values are installed to measure 16 active/reactive power flows, four active/reactive power injections, and four bus voltage magnitudes.

Additionally, a comparison experiment is performed between IEEE 118—and IEEE 1062—bus systems. Table 1 shows area-specific bus numbers of the IEEE 118—bus system and information on positions at which PMUs are installed. Underlined buses are buses in which the PMUs are installed.

TABLE 1

| Sub-areas | Buses |
|---|---|
| 1 | 1, 2, 3, 4, 5, 6, 7, 8, 9, 10, 11, 12, 13, 14, 15, 16, 17, 18, 19, |
| | 20, 117 |
| 2 | 21, 22, 23, 24, 25, 26, 27, 28, 29, 30, 31, 32, 70, 71, 72, 73, |
| | 74, 75, 113, 114, 115 |
| 3 | 33, 34, 35, 36, 37, 38, 39, 40, 41, 42, 43, 44, 45, 46, 47, 48, |
| | 49, 50, 51, 52, 53, 54, 55, 56, 57, 58, 59 |
| 4 | 68, 69, 76, 77, 78, 79, 80, 81, 82, 83, 84, 85, 86, 87, 88, 89, |
| | 90, 91, 92, 93, 94, 95, 96, 97, 98, 99, 116, 118 |
| 5 | 60, 61, 62, 63, 64, 65, 66, 67, 100, 101, 102, 103, 104, 105, |
| | 106, 107, 108, 109, 110, 111, 112 |

Now, SCADA and PMU measurements will be described. SCADA and PMU measurements are assumed to have noises with normal distribution, an average of 0 and variances 3σ_{k,sc} and 3σ_{k,pmu} of 0.01 (1%) and 0.001 (0.1%), respectively. PMU measurement is time-synchronized data and is more accurate than SCADA measurement. Accordingly, a variance value is set to be small.

As a performance assessment indicator of the comparison experiment, an AMAE is used and may be represented as shown in Equation 14 below.

$$AMAE := {\sum }_{n = 1}^{M} \{ {max}_{i} \vert x ( i ) - {\hat{x}}^{[ n ]} ( i ) \vert \} / M , \qquad [ Equation 14 ]$$

In Equation 14, M is the number of Monte Carlo simulations, and \hat{x}^{[n]}(i) is an i-th element of an estimation result \hat{x} of an n-th Monte Carlo simulation.

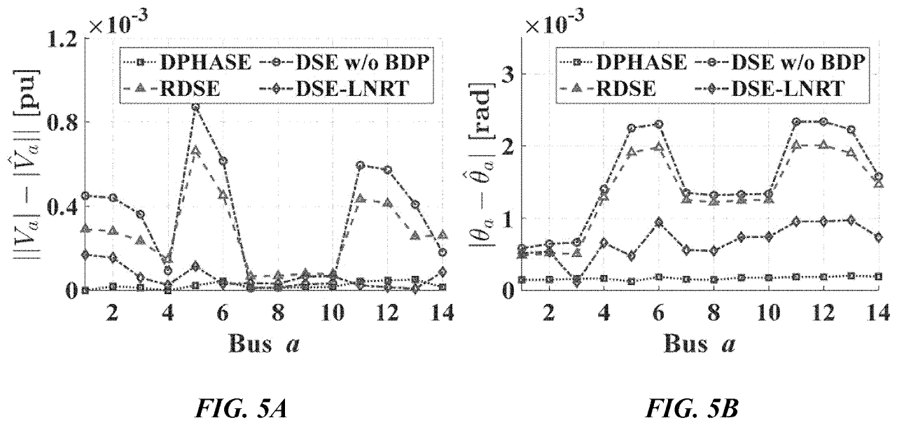

FIGS. 5A and 5B are a set of graphs for comparing estimation errors of a voltage magnitude and a phase angle in the simulation power system of FIG. 4 when SCADA BD is included.

As shown in FIGS. 5A and 5B, BD is included in active/reactive power flows P₂₋₃, P₅₋₆,P₇₋₉, Q₂₋₃, Q₅₋₆, and Q₇₋₉, and bus-specific absolute errors are comparatively shown as estimation errors. As experiment results, it is seen that the comparative examples have larger absolute errors than the present embodiment DPHASE. Comparative example 1 (DSE without BDP) has a largest absolute error in the voltage magnitude of an active/reactive power flow, and comparative example 3 (RDSE) has a largest absolute error in the voltage phase angle.

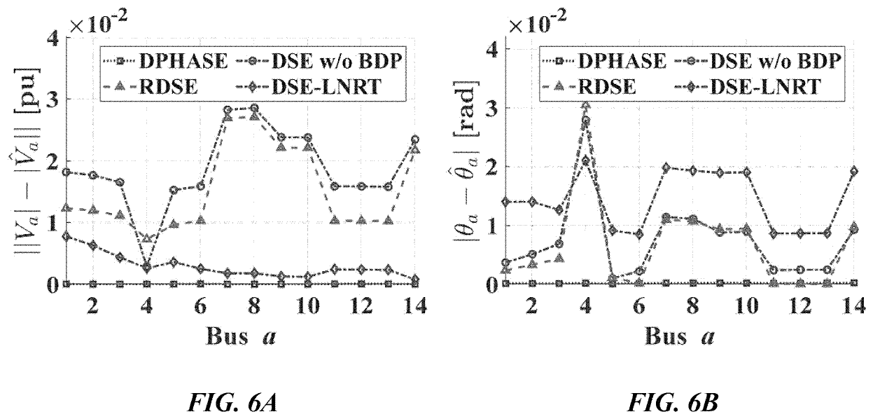

FIGS. 6A and 6B are a set of graphs for comparing estimation errors of a voltage magnitude and a phase angle in the simulation power system of FIG. 4 when PMU BD is included.

As shown in FIGS. 6A and 6B, BD is included in line current phasors I₂₋₃, I₅₋₆, and I₇₋₉,and bus-specific absolute errors are comparatively shown as estimation errors. As experiment results, it is seen that the comparative examples have larger absolute errors than the present embodiment DPHASE. Compared to the present embodiment (DPHASE), comparative example 1 (DSE without BDP) and comparative example 2 (RDSE) have a larger absolute error in the voltage phase angle of the line current phasors in buses other than I₇₋₈ and all the buses, respectively.

Referring to FIGS. 5A and 5B and FIGS. 6A and 6B, it is seen that the present embodiment (DPHASE) effectively reduces estimation errors on average compared to BDP algorithms of other comparative examples. In a specific bus, the present embodiment (DPHASE) may show a larger estimation error than the comparative examples, but the difference is smaller than σ_{k,sc} and σ_{k,pmu} which represent data uncertainty.

Table 2 and Table 3 below compare AMAEs of a case in which SCADA BD is included and a case in which PMU BD is included, respectively. In each case, a Monte Carlo simulation is performed 50 times, and it is assumed that a ratio of BD in the entire data is 10% and a percent error size is 30% of an actual value.

TABLE 2

| | Proposed | | Conventional | | | | | |
|---|---|---|---|---|---|---|---|---|
| AMAE | DPHASE | | DSE w/o BDP | | DSE-LNRT | | RDSE | |
| [×10⁻³] | \|V\| | θ | \|V\| | θ | \|V\| | θ | \|V\| | θ |
| 14-bus | 0.11 | 0.20 | 1.01 | 1.12 | 0.78 | 1.19 | 0.85 | 0.94 |
| 118-bus | 0.19 | 0.24 | 3.84 | 4.02 | 1.75 | 2.92 | 1.99 | 3.52 |
| 1062-bus | 0.17 | 0.18 | 8.99 | 9.57 | 3.08 | 3.23 | 4.37 | 8.52 |

TABLE 3

| | Proposed | | Conventional | | | | | |
|---|---|---|---|---|---|---|---|---|
| AMAE | DPHASE | | DSE w/o BDP | | DSE-LNRT | | RDSE | |
| [×10⁻³] | \|V\| | θ | \|V\| | θ | \|V\| | θ | \|V\| | θ |
| 14-bus | 5.0 | 5.4 | 70.3 | 35.3 | 58.8 | 31.8 | 67.4 | 34.3 |
| 118-bus | 7.2 | 5.9 | 84.5 | 56.8 | 63.3 | 46.6 | 77.0 | 54.7 |
| 1062-bus | 13.1 | 14.5 | 126.6 | 93.3 | 107.8 | 92.4 | 108.6 | 91.4 |

Referring to Table 2 and Table 3, the present embodiment (Proposed DPHASE) has a lower estimation error than the comparative examples (Conventional) in all simulations. The comparative examples (DSE-LNRT and RDSE) have a larger error than the present embodiment (DPHASE) because BDP is unsuccessful.

Table 4 shows BD determination results of the power system of FIG. 4. Since RDSE cannot be used for BD determination, DPHASE and DSE-LNRT are compared. In Table 4, “C” represents a case in which BD is accurately determined, “U” represents a case in which BD is not recognized, and “M” represents a case in which normal data is incorrectly determined as BD.

TABLE 4

| BD | | BD in SCADA meas. | | BD in PMU meas. | |
|---|---|---|---|---|---|
| scenarios | | Case 1 | Case 2 | Case 3 | Case 4 |
| BD | | \|V₆\|, P₂₋₃, P₆₋₁₃, | P₈, P₅₋₂, P₅₋₄, | Vᵣ₁, Vᵣ₃, Iᵣ₁₋₅, | Iᵣ₂₋₃, Iᵣ₅₋₆, Iᵣ₇₋₉, |
| | | P₉₋₁₀, Q₂₋₃, Q₆₋₁₃, | P₁₁₋₆, Q₈, Q₅₋₂, | Vᵢ₁, Vᵢ₃, Iᵢ₁₋₅ | Iᵢ₂₋₃, Iᵢ₅₋₆, Iᵢ₇₋₉ |
| | | Q₉₋₁₀ | Q₅₋₄, Q₁₁₋₆ | | |
| DPHASE | C | \|V₆\|, P₂₋₃, P₆₋₁₃, | P₈, P₅₋₂, P₅₋₄, | Vᵣ₁, Vᵣ₃, Iᵣ₁₋₅, | Iᵣ₂₋₃, Iᵣ₅₋₆, Iᵣ₇₋₉, |
| | | P₉₋₁₀, Q₂₋₃, Q₆₋₁₃, | P₁₁₋₆, Q₈, Q₅₋₂, | Vᵢ₁, Vᵢ₃, Iᵢ₁₋₅ | Iᵢ₂₋₃, Iᵢ₅₋₆, Iᵢ₇₋₉ |
| | | Q₉₋₁₀ | Q₅₋₄, Q₁₁₋₆ | | |
| DSE- | C | P₂₋₃, P₆₋₁₃, | P₈, P₅₋₂, | Vᵣ₁, Iᵣ₁₋₅, Iᵢ₁₋₅ | Iᵣ₅₋₆, Iᵢ₂₋₃, |
| LNRT | | Q₂₋₃, Q₆₋₁₃ | Q₈, Q_{5-2,} Q₁₁₋₆ | | Iᵢ₅₋₆, Iᵢ₇₋₉ |
| | U | P₉₋₁₀, Q₉₋₁₀, \|V₆\| | P_{5-4,} P_{11-6,} Q₅₋₄ | Vᵣ₃, Vᵢ₁, Vᵢ₃ | Iᵣ₂₋₃, Iᵣ₇₋₉ |
| | M | P₁₁₋₆, Q₁₁₋₆, | P_{1-2,} P_{6-13,} Vᵢ₁₂, | \|V₁\|, \|V₃\|, P₂₋₃, | P₂₋₃, P₅₋₄, Iᵣ₃₋₄ |
| | | Q₁₃₋₁₄, Vᵣ₁₂ | I_{r6-12,} I_{i6-11,} Iᵢ₆₋₁₂ | P₅₋₂, Q₂₋₃, Q₅₋₂, | |
| | | | | Iᵣ₃₋₄, Iᵣ₅₋₆ | |

Referring to Table 4, in the case of comparative example 3 (DSE-LNRT), specific BD remains unidentified, and some accurate data is incorrectly determined as BD. This is because BD also affects residuals of normal data due to correlation that has an influence when normalized residuals are calculated.

On the other hand, in the present embodiment (DPHASE), BD is successfully determined. This because, due to the independence of SCADA data and PMU data, bad SCADA data does not affect a PMU estimation result and bad PMU data does not affect a SCADA estimation result. Referring to Case 2 in Table 4, measurement data P₅₋₄ and Q₅₋₄ at the boundary is successfully processed as BD through state vector extension.

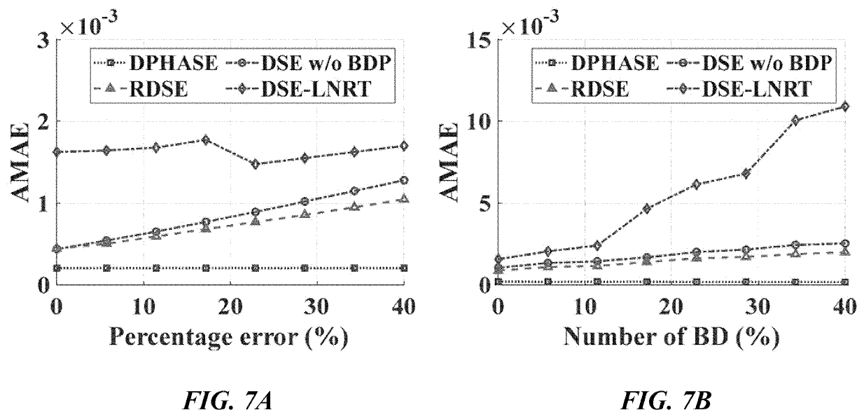

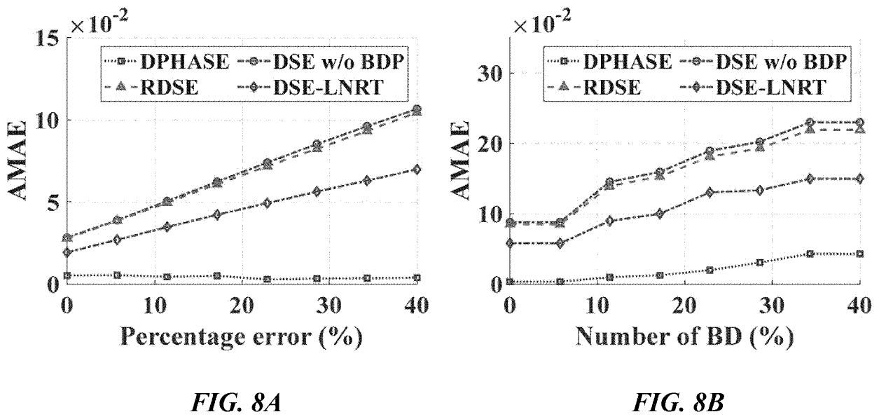

FIGS. 7A and 7B are a set of graphs for comparing estimation error AMAEs while increasing a BD error size and the number of pieces of BD in the simulation power system of FIG. 4 when SCADA BD is included. FIGS. 8A and 8B are a set of graphs for comparing estimation error AMAEs while increasing a BD error size and the number of pieces of BD in the simulation power system of FIG. 4 when PMU BD is included.

The purpose of this comparison experiment is to confirm that the present embodiment (DPHASE) has robustness to the size and number of pieces of BD compared to the comparative examples. As shown in FIGS. 7A and 7B and FIGS. 8A and 8B, AMAEs are checked while a percentage error and a ratio of the number of pieces of BD are increased from 0% to 40%.

In the present embodiment (DPHASE), even with an increase in a BD size and a BD ratio, errors hardly increase. On the other hand, in all of comparative example 1 (DSE without BDP), comparative example 2 (RDSE), and comparative example 3 (DSE-LNRT), estimation errors increase according to a BD size and a BD ratio.

As described above, in the present embodiment (DPHASE), BD is accurately determined and processed, and an AMAE increases due to a data recovery error only. Accordingly, the present embodiment (DPHASE) is robust to a BD size and ratio. On the other hand, in the case of DSE-LNRT and RDSE, an AMAE continuously increases when the number of cases in which BD is not recognized or normal data is incorrectly determined increase.

In Table 5, computational speeds of distribution algorithms are compared when SCADA BD is present at a ratio of 10%, PMU BD is present at a ratio of 10%, or each of SCADA BD and PMU BD is present at a ratio of 10%.

TABLE 5

| | | | Conventional | | |
|---|---|---|---|---|---|
| Bad | Test | Proposed | DSE | | |
| data | systems | DPHASE | w/o BDP | DSE-LNRT | RDSE |
| SCADA | 14-bus | 0.47 | 0.32 | 0.12 | 6.28 |
| (BD: 10%) | 118-bus | 5.12 | 4.78 | 2.39 | 113.47 |
| | 1062-bus | 24.25 | 21.44 | 39.35 | 121.00 |
| PMU | 14-bus | 0.14 | 0.10 | 0.26 | 0.95 |
| (BD: 10%) | 118-bus | 0.47 | 0.28 | 6.57 | 20.80 |
| | 1062-bus | 5.73 | 3.13 | 65.60 | 48.07 |
| SCADA | 14-bus | 0.65 | 0.42 | 0.45 | 9.10 |
| and PMU | 118-bus | 0.30 | 5.46 | 14.15 | 131.58 |
| (BD: 20%) | 1062-bus | 55.62 | 32.55 | 145.92 | 433.09 |

Referring to Table 5, the method of the present embodiment (DPHASE) has a longer computing time than other algorithms of the comparative examples. This is because the ADMM is performed twice to accurately determine BD. The computational speed is almost 1.5 times that of comparative example 1 (DSE w/o BDP).

Compared to comparative example 3 (DSE-LNRT), the method of the present embodiment (DPHASE) is slow in a small power system but can process BD faster in a large power system. In other words, in the case of processing a large number of pieces of BD, PHASE is faster than LNRT.

Also, compared to CSE employing LNRT, the method of the present embodiment (DPHASE) has a shorter computing time by 4.76 [s] at a BD ratio of 20% in the IEEE 118-bus simulation power system. Accordingly, distributed processing is more efficient than the centralized method.

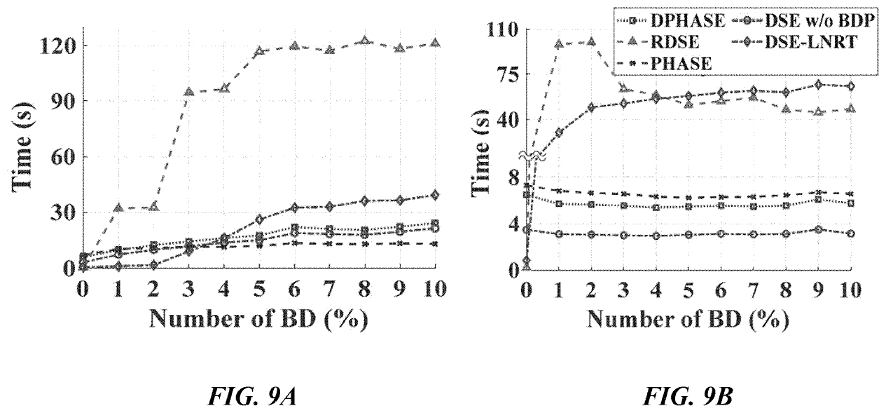

FIGS. 9A and 9B are a set of graphs for comparing computing times according to an increase or decrease in bad SCADA and PMU data ratios in the simulation power system of FIG. 4.

FIGS. 9A and 9B show the results of comparatively analyzing principles and performance of the present embodiment and comparative examples in the IEEE 14-bus system. In other words, FIGS. 9A and 9B show changes in average computing times for the IEEE 1062-bus system when a ratio of the number of pieces of BD increases from 0% to 10%.

Referring to FIG. 9A, when BD increases, a computing time of the present embodiment (DPHASE) continuously and gradually increases, but that of PHASE in a centralized manner is not significantly affected. The reason is that an increase in the number of pieces of BD reduces a convergence speed of the ADMM and affects the entire computing time.

In particular, in the case of damaged PMU data in the IEEE 118 and 1062-bus systems, the present embodiment (DPHASE) has a shorter computing time than comparative example 2 (DSE-LNRT) and comparative example 3 (RDSE). This is because, unlike a case of DSE-LNRT which operates on a one-to-one basis, all BD can be simultaneously processed in the present embodiment.

Also, unlike RDSE, the present embodiment (DPHASE) does not require an 11-norm penalty and a vector for the corresponding repetitive operation in ADMM-based DSE.

As described above, when the present embodiment is applied to an actual power system having a similar size to the IEEE 118 and 1062-bus systems, comparison experiment results show that the present embodiment can improve computing efficiency compared to the comparative examples (DSE-LNRT and RDSE).

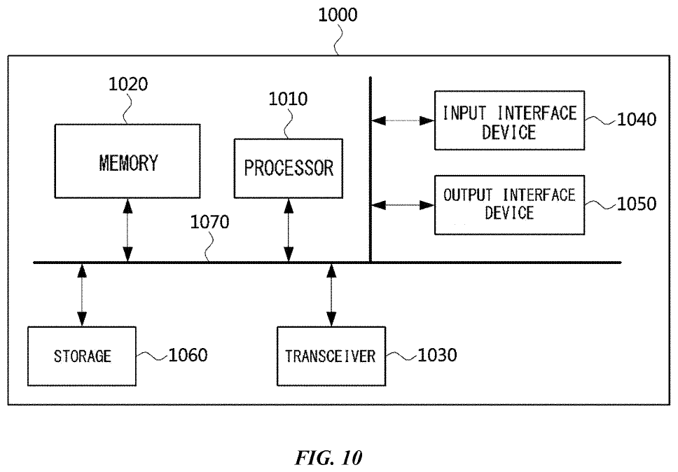

FIG. 10 is a block diagram illustrating a main device configuration that may be employed in a distribution method or a BDP method according to another embodiment of the present invention.

Referring to FIG. 10, as a computing device, a device 1000 that may be employed as a distribution device or a BDP device includes a processor 1010, a memory 1020 storing at least one command executed through the processor 1010 and results of processing the command, and a transceiver 1030 connected to a power system to perform communication.

Also, the device 1000 may further include an input interface device 1040, an output interface device 1050, a storage device 1060, etc. Each of the components included in the device 1000 may be connected through a bus 1070 and communicate with each other.

The processor 1010 may execute program commands stored in at least one of the memory 1020 and the storage device 1060. The processor 1010 may be a central processing unit (CPU), a graphics processing unit (GPU), or a dedicated processor for performing methods according to embodiments of the present invention.

Each of the memory 1020 and the storage device 1060 may be at least one of a volatile storage medium and a non-volatile storage medium. For example, the memory 1020 may be at least one of a read-only memory (ROM) and a random-access memory (RAM).

When the device 1000 of the present embodiment is employed in a distribution method and the device 1000 or the processor 1010 operates, the commands stored in at least one of the memory 1020 and the storage device 1060 may be loaded to the processor 1010, and the processor 1010 may function to execute the commands.

The commands may include a first command to receive a network topology related to SCADA and PMU measurements and position information of each piece of measurement equipment, a second command to establish an extended state vector set and extended state vectors for each sub-area, a 3a-th command to perform SCADA-based DSE using SCADA measurement for each sub-area and a covariance matrix of integrated vectors of the SCADA measurement and PMU measurement, a 3b-th command to perform PMU-based DSE using the PMU measurement for each sub-area and the covariance matrix of the integrated vectors of the SCADA measurement and the PMU measurement in parallel with the SCADA-based DSE, a fourth command to mix results of the SCADA-based DSE and the PMU-based DSE and perform a phasor-aided normalized residual test and a general normalized residual test, etc.

When the device 1000 of the present embodiment is employed in a H-DSE algorithm or a BDP method in H-DSE algorithm and the device 1000 or the processor 1010 operates, the commands stored in at least one of the memory 1020 and the storage device 1060 may be loaded to the processor 1010, and the processor 1010 may function to perform at least one operation of the H-DSE algorithm or the BDP method in H-DSE.

In addition to the above-described first, second, 3ath, 3bth, and fourth commands, the commands may include a command to determine whether there is BD in SCADA and PMU measurements for each sub-area, a command to fuse results of SCADA-based and PMU-based DSE algorithms when it is determined that there is no BD, a command to remove BD and recover data using a matrix completion method when it is determined that there is BD, a command to perform additional DSE using SCADA and PMU measurements recovered in the recovery operation, a command to fuse results of SCADA-based DSE and PMU-based DSE, etc. Here, the command to perform additional SE may include a command to generate additional SCADA data and additional PMU data by performing ADMM-based DSE.

According to the present invention, when the ADMM is used for distributed power system SE algorithm, the operating state of a large-scale system can be monitored by exchanging only state information of adjacent sub-areas. In addition, it is possible to effectively supplement a margin of a measurement value reduced at a boundary through data exchange between sub-areas.

Also, according to the present invention, a PHASE method is applied to H-DSE in SCADA and PMU data is taken into consideration, and the H-DSE to which PHASE is applied is compared with a conventional DSE algorithm to determine whether there is BD so that a high BD determination success rate can be obtained.

Further, according to the present invention, it is possible to provide a H-DSE algorithm which has advantages of high computation efficiency, low BD sensitivity, and high estimation accuracy compared to a CSE algorithm currently commercialized and used in large-scale power systems, or a BDP method in H-DSE. In this way, the present invention can contribute to efficiency improvement through optimal system operation and system stabilization through failure situation detection, failure location search, and optimal control of distributed resources.

In addition, according to the present invention, it is possible to provide a distribution method which has verified effects in large-scale power systems compared to conventional algorithms and is excellent in estimation accuracy, analysis of sensitivity to the number of pieces of BD and a BD size, computational speed assessment, etc. as a result of applying a Monte Carlo method 100 times to various cases to verify performance of an algorithm of the distribution method of the present embodiment, and a H-DSE algorithm or a BDP method using the same.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a communication network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A decentralized phasor-aided state estimation (DPHASE) method for monitoring an operating state of a large-scale power system, the method comprising:
establishing extended state vectors and an extended state vector set for each sub-area on the basis of a network topology related to measurements of a supervisory control and data acquisition (SCADA) system and a phasor measurement unit (PMU), and position information of each piece of measurement equipment;
performing SCADA-based distributed state estimation (DSE) only using SCADA measurement for each sub-area and a covariance matrix of integrated vectors of the SCADA measurement and PMU measurement;
performing PMU-based DSE using the PMU measurement for each sub-area and the covariance matrix of the integrated vectors of the SCADA and the PMU measurements in parallel with the SCADA-based DSE; and
mixing estimation results of the SCADA-based and the PMU-based DSE algorithms and performing a phasor-aided normalized residual test and a general normalized residual test.

2. The method of claim 1, wherein the performing of the SCADA-based DSE and the PMU-based DSE in parallel comprises generating SCADA and PMU distribution states of each sub-area using alternating direction method of multipliers (ADMM)-based DSE while interacting with an adjacent estimator.

3. The method of claim 1, further comprising, after the performing of the phasor-aided normalized residual test and the general normalized residual test, determining whether there is bad data (BD) in the SCADA and the PMU measurements for each sub-area.

4. The method of claim 3, further comprising, when there is no BD, fusing the results of the SCADA-based DSE and the PMU-based DSE.

5. The method of claim 3, further comprising, when there is BD, removing the BD and recovering data using a matrix completion method.

6. The method of claim 5, further comprising performing additional DSE using SCADA and PMU measurements recovered in the recovering of the data.

7. The method of claim 6, wherein the performing of the additional DSE comprises generating additional SCADA data and additional PMU data by performing alternating direction method of multipliers (ADMM)-based DSE.

8. The method of claim 6, further comprising, after the performing of the additional state estimation, fusing the results of the SCADA-based and the PMU-based DSE algorithms.

9. A bad data processing method in hybrid distributed state estimation (H-DSE) algorithm for monitoring an operating state of a large-scale power system, the method comprising:
mixing estimation results of supervisory control and data acquisition (SCADA)-based and phasor measurement unit (PMU)-based distributed state estimation (DSE) algorithms and performing a phasor-aided normalized residual test and a general normalized residual test; and
determining whether there is a bad data (BD) in SCADA and PMU measurements for each sub-area,
wherein each sub-area is defined by a network topology related to the SCADA measurement and the PMU measurement and position information of measurement equipment according to the network topology.

10. The method of claim 9, further comprising, when there is no BD, fusing the results of the SCADA-based DSE and the PMU-based DSE.

11. The method of claim 10, further comprising, when there is BD, removing the BD and recovering data using a matrix completion method.

12. The method of claim 11, further comprising performing additional state estimation (SE) using SCADA and PMU data recovered in the recovering of the data.

13. The method of claim 12, wherein the performing of the additional SE comprises generating additional SCADA-based and additional PMU-based estimates by performing alternating direction method of multipliers (ADMM)-based DSE.

14. The method of claim 12, further comprising, after the performing of the additional SE, fusing the results of the SCADA-based and the PMU-based DSE algorithms.

15. The method of claim 9, further comprising, before the performing of the phasor-aided normalized residual test and the general normalized residual test, establishing extended state vectors and an extended state vector set for each sub-area.

16. The method of claim 15, further comprising, after the establishing of the extended state vectors and the extended state vector set, performing the SCADA-based DSE and the PMU-based DSE in parallel,
wherein the performing of the SCADA-based DSE and the PMU-based DSE in parallel comprises generating, by a SCADA estimator and a PMU estimator, SCADA and PMU distribution states of each sub-area using alternating direction method of multipliers (ADMM)-based DSE while interacting with an adjacent estimator.

17. A device for performing a bad data processing method in hybrid distributed state estimation (H-DSE) algorithm for monitoring an operating state of a large-scale power system, the device comprising:
a memory configured to store at least one command; and
a processor connected to the memory and configured to execute the at least one command,
wherein, when the processor operates, the at least one command causes the processor to perform operations of:
mixing estimation results of supervisory control and data acquisition (SCADA)-based and phasor measurement unit (PMU)-based hybrid distributed state estimation (DSE) algorithms and performing a phasor-aided normalized residual test and a general normalized residual test; and
determining whether there is a bad data (BD) in SCADA measurement for each sub-area and PMU measurement for each sub-area,
wherein each sub-area is distinguished or defined by a network topology related to the SCADA and the PMU measurements and position information of measurement equipment according to the network topology.

18. The device of claim 17, wherein, after the determining of whether there is BD in the SCADA measurement for each sub-area and the PMU measurement for each sub-area, the at least one command causes the processor to further perform operations of:
when there is BD, removing the BD and recovering data using a matrix completion method;
performing additional state estimation using SCADA and PMU measurements recovered in the recovering of the data wherein the performing of the additional state estimation comprises performing alternating direction method of multipliers (ADMM)-based DSE to generate additional SCADA data and additional PMU data; and
fusing the results of the SCADA-based DSE and the PMU-based DSE.

19. The device of claim 17, wherein, after the determining of whether there is BD in the SCADA and the PMU measurements for each sub-area, the at least one command causes the processor to further perform an operation of fusing the results of the SCADA-based DSE and the PMU-based DSE when there is no BD.

20. The device of claim 17, wherein, before the mixing of the estimation results of the SCADA-based and the PMU-based DSE algorithms and the performing of the phasor-aided normalized residual test and the general normalized residual test, the at least one command causes the processor to further perform operations of:
receiving a network topology related to SCADA and PMU measurements and position information of each piece of measurement equipment;
establishing extended state vectors and an extended state vector set for each sub-area; and
performing the SCADA-based DSE using the SCADA measurement for each sub-area and a covariance matrix of integrated vectors of the SCADA measurement and the PMU measurement and performing the PMU-based DSE using the PMU measurement for each sub-area and the covariance matrix of the integrated vectors of the SCADA measurement and the PMU measurement in parallel with the SCADA-based DSE.
